(19) United States
(12) Patent Application Publication
(10) Pub. No.: US 2022/0263213 A1
(43) Pub. Date: Aug. 18, 2022

(54) ANTENNA ARRANGEMENT FOR CEILING MOUNTED DEVICE

(71) Applicant: Zuma Array Limited, London, Greator London (GB)

(72) Inventors: Morten WARREN, London, Greater London (GB); Edward ROSE, London, Greater London (GB); Brian COLLINS, Ely, Cambridgeshire (GB)

(73) Assignee: Zuma Array Limited, London, Greater London (GB)

(21) Appl. No.: 17/624,867

(22) PCT Filed: Jul. 6, 2020
(86) PCT No.: PCT/EP2020/069035

§ 371 Date: Jan. 5, 2022

(30) Foreign Application Priority Data
Jul. 5, 2019 (GB) 1909665.0

(51) Int. Cl. H01Q 1/00; H01Q 1/44; H01Q 9/04; H01Q 1/48; H01Q 5/357; H04R 1/02; F21S 8/02; F21V 33/00; F21V 21/04

(52) U.S. Cl. CPC H01Q 1/007; H01Q 1/44; H01Q 9/0421; H01Q 1/48; H01Q 5/357; H04R 2201/021; H04R 1/026; F21S 8/026; F21V 33/0056; F21V 21/044; H04R 1/028

(57) ABSTRACT

An antenna is provided. The antenna comprises a dielectric lamina having a first face and a second face opposite the first face. The antenna further comprises a groundplane on the first face of the dielectric lamina, wherein the groundplane is a planar conductive groundplane comprising first and second L-shaped apertures. The antenna further comprises a microstrip transmission line on the second face of the dielectric lamina.

### OBJECT OF THE INVENTION

The object of the invention is to provide low cost antennas supporting reliable wireless communications for a ceiling mounted device.

### BACKGROUND OF THE INVENTION

A ceiling-mountable loudspeaker and lighting system is housed in a cylindrical electrically conductive housing having a closed upper end and an open lower end, the lower end having an outwardly projecting flange whose primary function is to locate the housing against the lower surface of a ceiling or other supporting structure. The supporting ceiling may typically be constructed from plasterboard, medium density fiberboard (MDF) or plywood. The space inside the cylindrical housing is filled with functional components such as loudspeaker drivers and LED lights, and further electronics circuits may be connected to the circuits and devices within the housing by means of external cables.

It is required to provide wireless communications with the contained and connected electronics circuits, for example by the use of the ISM (industrial, scientific and medical) frequency bands used for WiFi, Bluetooth™ and other services. This communications functionality is used to stream music and other audio content between a management station and a number of connected devices, and to carry control and other management messages. The relative physical orientation of other devices and the management station are arbitrary, so it is required that to the maximum extent possible, reliable all-round coverage is provided by the antenna system.

Considerations of acoustic design require that the device has significant mass and for this reason is constructed from metal. To provide an aesthetically pleasing appearance the total diameter of the device is constrained to be as small as possible, with the result that the radial width of the projecting flange must be minimised. Ceiling structures may be provided with metallic foil on their upper surfaces to enhance thermal insulation, so it is desirable that the antennas be housed within the radial flange which is the only component of the device that projects below the ceiling.

It is therefore required that the antenna (or antennas) of the device be housed within the radially projecting conductive flange, each antenna providing for transmission and reception on appropriate frequency bands. These frequency bands are typically 2.4-2.485 GHz and 4.9-5.8 GHz. These are referred to as the 2.4-GHz and 5-GHz bands. It is also desirable that the radial extent of the flange is small. The flange may be exposed to possible damage during the installation of the device.

Fitting electrically small antennas to a conductive body is intrinsically difficult. The present invention provides an arrangement that overcomes this challenge.

### BRIEF SUMMARY OF THE INVENTION

The invention is a further development of the dual-band notch antenna described in PCT application WO 2105/011468 A1 in which both the mechanical and electrical configuration are adapted to the severe constraints imposed by the dimensional and physical requirements of the present application. The arrangement enables dual-band operation in the 2.4-GHz and 5-GHz bands and allows for the provision of four antennas spaced round the circumference of the outwardly projecting flange whose radial width is only around 9 mm (0.072 wavelengths at 2.4 GHz).

Each antenna comprises dual L-shaped slots in a conductive groundplane excited by a microstrip transmission line and is fabricated using printed circuit methods on a first arcuate planar dielectric lamina housed in a shaped recess provided in the outwardly projecting conductive flange at the lower end of a cylindrical conductive housing. Each antenna further comprises a second dielectric lamina having no surface copper layers whose function is to provide additional mechanical stability for the first lamina. The recess provided for each antenna accommodates the thickness of the antenna, and provides for a subminiature coaxial connector to enable connection of the microstrip feedline of the antenna to a coaxial cable connected to corresponding radio circuit arrangements.

In one example, an antenna comprises a dielectric lamina (substrate) having a first face and a second face opposite the first face, a groundplane on the first face of the dielectric lamina and a microstrip transmission line on the second face of the dielectric lamina. The groundplane is a planar conductive groundplane comprising first and second L-shaped apertures.

The dielectric lamina may have a thickness of 0.8 mm. The dielectric lamina may have a length of 34 mm. Where the lamina is arcuate, this may be the circumferential length. The dielectric lamina may have a width of 9 mm (or 9.0 mm). Where the lamina is arcuate, this may be the radial width. The dielectric lamina may have a relative permittivity of 4.0.

The microstrip transmission line may be a radio frequency, RF, transmission line.

In the context of this application, “L-shaped” means shaped like the uppercase letter “L” in the basic Latin alphabet and generally describes a two-dimensional shape having first and second elongate portions, each portion having two ends. An end of the first elongate portion is joined to an end of the second elongate portion so that the major axes of the elongate portions are approximately perpendicular. Each elongate portion has a width and a length where the length is greater than the width.

A more specific “L-shape” is a block capital letter L and has six sides in which 5 of the internal angles are approximately 90 degrees and the remaining internal angle is approximately 270 degrees. The sides may be straight or may be arcuate.

The groundplane may comprise an edge. The first L-shaped aperture may be adjacent to the edge of the groundplane so that a first conductive track is defined by a portion of the groundplane between the edge of the groundplane and the first L-shaped aperture. The second L-shaped aperture may be adjacent to the edge of the groundplane so that a second conductive track is defined by a portion of the groundplane between the edge of the groundplane and the second L-shaped aperture.

In the context of this application, an edge may be straight or substantially straight or may be arcuate.

The first and second L-shaped apertures may be adjacent to each other so that a third conductive track (a conductive region) is defined by the portion of the groundplane between the first and second L-shaped apertures.

In the context of this application, “parallel” may describe lines where the perpendicular distance between the lines is substantially the same along the length of the lines. This can refer to straight or arcuate lines. For example, arcuate lines defining portions of concentric circles may be said to be parallel. Parallel may not mean exactly parallel but rather substantially parallel. For example, two radii of a circle that are separated by a small angle may appear substantially parallel at a distance from the origin of the circle.

In the context of this application, “perpendicular” generally means “at 90 degrees”. However, variations in the exact angle may be possible. For example, angles between 80 degrees and 100 degrees may be described as perpendicular.

The first L-shaped aperture may comprise a first edge parallel to the edge of the groundplane so that the first conductive track is defined between the edge of the groundplane and the first edge of the first aperture. The first L-shaped aperture may further comprise a second edge opposite the first edge of the first aperture. The second edge may be parallel to (or concentric with) the first edge of the first aperture. The first L-shaped aperture may further comprise a third edge extending between (and joining together) the first and second edges of the first aperture. The third edge may be perpendicular to the first and second edges.

The length of the first edge of the first L-shaped aperture may be 9 mm. The length of the third edge of the first L-shaped aperture may be 7 mm.

The second L-shaped aperture may comprise a first edge parallel to the edge of the groundplane so that a second conductive track is defined by a portion of the groundplane between the edge of the groundplane and the first edge of the second aperture. The second L-shaped aperture may further comprise a second edge opposite the first edge of the second aperture and parallel to (or concentric with) the first edge of the second aperture. The second L-shaped aperture may further comprise a third edge extending between the first and second edges of the second aperture. The third edge of the second aperture may be adjacent to the third edge of the first aperture so that the third conductive track is defined by a portion of the groundplane between the third edge of the first aperture and the third edge of the second aperture. The third edge may be perpendicular to the first and second edges.

The length of the first edge of the second L-shaped aperture may be 4 mm. The length of the third edge of the first L-shaped aperture may be 7 mm.

In some examples, the first and second edges of the first L-shaped aperture define arcs of circles having a common origin (in other words, they are portions of concentric circles). The third edge may be a portion of a radius of the larger circle that joins the arcs together. The same may be true of the first, second and third edges of the second L-shaped aperture.

In some examples, the first and second conductive tracks may be the same width.

In some examples, the third edge of the first aperture may be parallel to the third edge of the second aperture. The portion of the groundplane between the third edge of the first aperture and the third edge of the second aperture may form a third track. In some examples, the lines may be portions of radii of a common circle so that the edges are not quite parallel but are substantially parallel.

The first L-shaped aperture may comprise a fourth edge between the second edge of the first L-shaped aperture and the first edge of the first L-shaped aperture and opposite the third edge of the first L-shaped aperture. The fourth edge of the first L-shaped aperture may be a step. In this way, the first to fourth edges of the aperture may together form a block L-shape.

The second L-shaped aperture may comprise a fourth edge between the second edge of the second L-shaped aperture and the first edge of the second L-shaped aperture and opposite the third edge of the second L-shaped aperture. The fourth edge of the second L-shaped aperture may be a step. In this way, the first to fourth edges of the second aperture may together form a block L-shape.

Formed as a step can mean that the line contains three portions: a first portion; a second portion perpendicular to the first portion; and a third portion perpendicular to the second portion, so that the first portion and the third portion are parallel.

A block L-shape may comprise: two long edges; two short edges; and two end edges. The short edges are each adjacent to a vertex of the L-shape having an internal angle of approximately 270 degrees. The remaining five vertices of the L-shape may have an internal angle of approximately 90 degrees. The end edges may each share a vertex with a respective short edge (and the long edges also share a vertex with each other). The long edges may each share a vertex with a respective end edge.

The two long edges of the first and/or second block L-shaped aperture may be provided by the first and third edges of the respective aperture. The short edges may each be provided by a portion of the fourth edge of the respective aperture (the second and third portion of the fourth edge of the respective aperture). The end edges may be provided by the remaining portion of the fourth edge of the respective aperture (the first portion) and the second edge of the respective aperture.

The first portion of the fourth edge of the first and/or second aperture (the end edge of the block L-shape) may be connected to the first edge of the respective aperture. The first edge of the first and/or second aperture may therefore be longer than the second edge of the respective aperture. This configuration of the step in the fourth edge of the respective aperture is preferred (as shown in the drawings).

In an alternative configuration, the first portion of the fourth edge of the first and/or second aperture (the end edge of the block L-shape) may be connected to the second edge of the respective aperture. In this way, the second edge may be longer than the first edge.

The first and/or second L-shaped apertures may further comprise additional features to improve the characteristics of the antenna. For example, there may be additional portions removed from the groundplane (thereby enlarging the area of the aperture). There may also be portions of the groundplane extending into the L-shaped of the aperture (thereby reducing the area of the aperture).

The groundplane may further comprise a first gap between the first conductive track and the third conductive track. The groundplane may further comprise a second gap between the second conductive track and the third conductive track.

In the context of this application, a gap may be defined as a break in the conductive groundplane where electric current cannot flow directly across the gap.

The second edge and the third edge of the first and/or second apertures may be connected. However, the gap may separate the first edge and the third edge of the respective aperture so that these edges are not directly connected.

The third conductive track may extend to the edge of the groundplane. In this way, an end of the third conductive track may be aligned with the edge of the groundplane.

The groundplane may further comprise a fourth conductive track extending from an end of the first conductive track adjacent the first gap towards the second edge of the first aperture. The track may not extend all the way to the second edge so that a third gap exists between the fourth conductive track and the second edge of the first aperture. The fourth conductive track may be spaced apart from the third conductive track so that the first gap extends between the fourth conductive track and the third conductive track. The fourth conductive track may therefore extend into the first L-shaped aperture.

In the context of this application, a “conductive track” is a strip of metal (for example on the dielectric lamina) with parallel sides. The conductive track may be straight, substantially straight or arcuate.

The first L-shaped aperture may be dimensioned so that the length of the second edge is greater than the width of the fourth conductive track. Therefore, the fourth conductive track can extend most of the way toward the second edge without overlapping the groundplane.

The fourth conductive track may extend at least 50% of the distance across the first aperture. In other words, at least 50% of the distance to the second edge. In some examples, the fourth conductive track may extend at least 60%, 70%, 80%, 90%, 95% or 99% of the distance across the first aperture.

The antenna may further comprise a fifth conductive track that extends from an end of the second conductive track adjacent the second gap towards the second edge of the second aperture. The fifth conductive track may not extend all the way to the second edge of the second L-shaped aperture so that a fourth gap exists between the fifth conductive track and the second edge of the second aperture. The fifth conductive track may be spaced apart from the third conductive track so that the second gap extends between the fifth conductive track and the third conductive track. In this way, the fifth conductive track extends into the second L-shaped aperture.

The second L-shaped aperture may be dimensioned so that the length of the second edge is less than the width of the fifth conductive track. Therefore, if the length of the fifth conductive track were greater than the length of the first portion of the fourth edge, the fifth conductive track would extend beyond the aperture and overlap the ground plane. The length of the fifth conductive track is therefore preferably less than the length of the first portion of the fourth edge so that a gap exists between the fifth conductive track and the second portion of the fourth edge.

The length of the fifth conductive track may be between 10% and 20% of the distance across the second aperture.

The widths of the first, second, third, fourth and fifth conductive tracks may all be the same width or may have different widths. The widths of the conductive tracks may be selected independently, depending on design criteria (for example, manufacturing constraints) and desired frequency response of the antenna.

The transmission line may pass across first and second portions of the second face of the dielectric laminar that are opposite each of the first and second L-shaped apertures, respectively.

The transmission line on the second face of the dielectric lamina may overlap the ground plane on the first face of the dielectric lamina by a distance of 1.2 mm at the distal end of the transmission line.in other words, the transmission line may pass across the first aperture and extend beyond the extent of the first aperture by a distance of 1.2 mm.

The transmission line may comprise a first conductive track on the second face of the dielectric lamina. The first conductive track of the transmission line may be substantially parallel to (or concentric with) the edge of the groundplane. In other words, if the edge of the groundplane were projected from the first face of the dielectric lamina onto the second face of the dielectric lamina, the first conductive track of the transmission line would be parallel to the projected edge. A distal end of the first conductive track of the transmission line may be an open circuit. In other words, the distal end is terminated by a capacitive open circuit stub. A proximal end of the first conductive track opposite the distal end may provide a feed for the antenna.

The transmission line may have a width of 0.8 mm (or 0.80 mm). Alternatively, the transmission line may have a width of 1 mm or (or 1.0 mm). The transmission line may have a length between 15 mm and 25 mm (preferably around 20 mm).

The transmission line may further comprise a second conductive track on the second face of the dielectric lamina. The second conductive track of the transmission line may also be referred to as a first branch of the transmission line. The second conductive track may be perpendicular to and extending from the first conductive track. The second conductive track of the transmission line may be opposite (at least a portion of) the third conductive track of the groundplane. In other words, the second conductive track of the transmission line and the third conductive track of the groundplane are positioned in the same place on the dielectric lamina but on opposite faces.

The second conductive track may be positioned 6 mm to 9 mm from the distal end of the first track. The second conductive track may be positioned 10 mm (or 10.13 mm) from the proximal end of the first track. The second conductive track may have a length of around 4.5 mm (or 4.50 mm). The second conductive track may have a width of around 1 mm (or 1.0 mm).

The transmission line may further comprise a third conductive track (also called a second branch) on the second face of the dielectric lamina. The third conductive track may be perpendicular to and extending from the first conductive track. The second branch may be closer to the proximal end of the transmission line than the first branch is.

The third conductive track may be positioned 7 mm from the proximal end of the first track. The third conductive track may have a length of 1 mm to 2 mm (preferably 1.5 mm). The third conductive track may have a width of around 1 mm.

The antenna may further comprise an RF connector. An inner connection of the RF connector may be conductively connected to the proximal end of the transmission line. The conductive coupling may be achieved by a solder bond. The RF connector may be mounted on the second face of the dielectric lamina.

An outer connection of the RF connector may be conductively connected to the groundplane.

A first ground area may be provided on the second face of the dielectric lamina opposite a portion of the groundplane on the first face of the dielectric lamina and conductively connected therewith. Conductive connectivity may be achieved using vias or plated through-holes passing through the dielectric lamina. The portion of the groundplane opposite the first ground area may be adjacent to the second L-shaped aperture but not overlapping with the second L-shaped aperture (or the first L-shaped aperture). An outer connection of the RF connector may be conductively connected to the ground area by a solder bond.

The first ground area may comprise an opening and the RF connector may be mounted in the opening. In other words, the ground area extends to sides of the RF connector but does not extend beneath the RF connector.

Vias (or through-holes) may be placed close to the periphery of the ground area. The vias (or through-holes) may be spaced at intervals. Preferably, the distance between adjacent through holes is less than 6 mm. The spacing between through holes may be less than 5 mm, 4 mm or 3 mm.

A second ground area may be provided on the second face of the dielectric lamina opposite a portion of the groundplane on the first face of the dielectric lamina and conductively connected therewith. Conductive connectivity may be achieved using vias or plated through-holes passing through the dielectric lamina. The portion of the groundplane opposite the first ground area may be adjacent to the first L-shaped aperture but not overlapping with the first L-shaped aperture (or the second L-shaped aperture).

The first and/or second ground area may be provided by a conductive foil.

The first aperture may be dimensioned to provide operation on a first frequency band. The first frequency band may be the 2.4 GHz frequency band, which covers frequencies of 2.4-2.485 GHz. The second aperture may be dimensioned to provide operation on a second frequency band. The second frequency band may be the 5 GHz frequency band, which covers 4.9-5.8 GHz.

The arrangement may provide mutual isolation between the antennas of at least 25 dB in the 2.4 GHz band and 28 dB in the 5-GHz band.

The antenna may be operative on frequency bands designated for the streaming of digital audio data and the transmission of control data.

The groundplane of the antenna may be of substantially arcuate form, and the first and second L-shaped apertures may extend radially and circumferentially therein.

An antenna arrangement is also provided. The antenna arrangement comprises an antenna as described above and a substantially planar conductive member having a first face and a second face opposite the first face. The antenna is mounted in a recess in the first face of the substantially planar conductive member. The recess is dimensioned to accommodate the antenna and may also accommodate a cable connected thereto. The antenna and cable may be accommodated so that the antenna and cable do not protrude beyond the recess. The substantially planar conductive member further comprises an opening in the second face (so that the opening extends through to the recess). The opening is be shaped so that the first and second L-shaped apertures in the groundplane align with the opening in the second face of the substantially planar conductive member.

In this way, the antenna is able to transmit/receive data (on the first and second frequency bands) through the opening in the planar conductive member.

An antenna arrangement is also provided. The antenna arrangement comprises a substantially planar conductive member having a first face and a second face opposite the first face, and one or more recesses in the first face. Each recess has a respective antenna according as described above mounted therein. Each recess is dimensioned to accommodate the respective antenna and each antenna may also connectable with a cable so that the recess accommodates the respective cable when connected to the respective antenna. In other words, the antenna and cable do not protrude beyond the respective recess. Each recess corresponds with a respective opening in the second face of the substantially planar conductive member (so that the corresponding opening extends through to the recess). Each opening is shaped to align with the first and second L-shaped apertures in the groundplane of the respective antenna mounted in the respective opening (so that the first and second L-shaped apertures are not covered by the second face of the substantially planar conductive member).

The antenna arrangement may comprise two, three, or four antennas.

At least two antennas may be accommodated within the planar conductive member and may be configurable with electronic circuit arrangements to provide simultaneous operation on at least two wireless interface protocols.

At least four antennas may be accommodated within the planar conductive member and may be configurable with electronic circuit arrangements to provide simultaneous operation on at least two wireless interface protocols and to provide diversity operation on each of the at least two wireless interface protocols.

At least two antennas may be provided and configured to provide MIMO operation.

The planar conductive member may be an aluminium planar conductive member.

Each opening in the second face of the planar conductive member may be dimensioned so that the boundary of the opening is at least a predetermined distance from the first and second L-shaped apertures of the respective antenna. The predetermined distance may be 0.5 mm. The predetermined distance may be 1.0 mm.

An edge of the planar conductive member may be of curved or circular form.

The planar conductive member may be a flange outwardly extending from a substantially cylindrical body. The flange may be a mounting flange.

The substantially cylindrical body may be conductive.

The groundplane of each antenna may be proximate to a surface of the respective recess and may be electrically insulated therefrom by a dielectric film. A capacitive connection may be made between the groundplane of each antenna and the proximate surface of the respective recess.

The dielectric film may be provided by double-sided adhesive tape, solder resist, and/or anodising of an the proximate surface of the respective recess. The planar conductive member may be aluminium and the anodising may be anodising of the aluminium surface of the surface of the recess.

A lighting and/or loudspeaker device is also provided. The lighting and/or loudspeaker device comprises an antenna arrangement as described above.

The lighting and/or loudspeaker device may further comprising a housing having a front end from which light and/or sound is configured to project. The antenna arrangement may be provided in the form of a flange at the front end of the housing.

Advantageously, the antenna arrangement is positioned at the front of the device so that electromagnetic signals can be transmitted and/or received to/from the antenna arrangement.

The lighting and/or loudspeaker device may be suitable for mounting in a ceiling aperture in a ceiling. The flange may engage a front of the ceiling when the lighting and/or loudspeaker device is mounted in the ceiling aperture. The lighting and/or loudspeaker device further may comprise a biasing member mounted to the housing configured to engage and exert a force against a rear side of the ceiling when the lighting and/or loudspeaker device is mounted in the ceiling aperture to brace the lighting and/or loudspeaker device against the ceiling.

The ceiling may comprise an electrically insulating material such as plasterboard, MDF or plywood. A metallic foil may be present on the upper (rear) surface of the ceiling to enhance thermal insulation. Advantageously, providing the antenna arrangement on the flange of the device allows signals to be transmitted/received into the room, without being shielded/reflected/attenuated by the metallic foil.

### CLAUSES

Clause 1 An antenna comprising dielectric lamina having a planar conductive groundplane on a first face and a microstrip radio frequency transmission line on a second face, the groundplane having two L-shaped openings wherein:

The microstrip line is substantially parallel to edge of groundplane, passing across each aperture, and being terminated by a capacitive open circuit stub; and

The first aperture and the second aperture are dimensioned to provide operation on a first frequency band and a second frequency band.

Clause 2 An antenna according to clause 1 in which the in which the planar conductive groundplane is of substantially arcuate form with apertures extending radially and circumferentially therein.
Clause 3 An antenna according to clause 1 or clause 2 housed in an edge of a substantially planar conductive member having an opening shaped to accommodate the openings in the groundplane of the antenna.
Clause 4 An arrangement in which an antenna according to clause 3 is housed in a recess is provided in the planar conductive member dimensioned in shape and depth such that the antenna and a cable connected thereto are entirely accommodated within the thickness of the said substantially planar conductive member.
Clause 5 An arrangement according to clause 4 wherein an edge of the planar conductive member is of curved or circular form
Clause 6 An arrangement according to clause 5 wherein the planar conductive member is a flange outwardly extending from a substantially cylindrical body
Clause 7 An arrangement according to clause 6 wherein the substantially cylindrical body is conductive
Clause 8 An arrangement according to clause 7 in which the substantially cylindrical body comprises a loudspeaker housing.
Clause 9 An arrangement according to clause 6 wherein the outwardly extending flange is a mounting flange.
Clause 10 An antenna according to any of the preceding clauses being operative on frequency bands designated for the streaming of digital audio data and the transmission of control data.
Clause 11 An antenna according to any of the preceding clauses being operative on frequency bands such as 2.4-2.485 GHz and 4.9-5.8 GHz.
Clause 12 An arrangement according to any of the preceding clauses wherein at least two antennas are accommodated within a planar conductive member and are configured with electronic circuit arrangements to provide diversity operation.
Clause 13 An arrangement according to any of the preceding clauses wherein at least two antennas are accommodated within a planar conductive member and are configured with electronic circuit arrangements to provide simultaneous operation on at least two wireless interface protocols.
Clause 14 An arrangement according to any of the preceding clauses wherein at least four antennas are accommodated within a planar conductive member and are configured with electronic circuit arrangements to provide simultaneous operation on at least two wireless interface protocols and to provide diversity operation on each of the at least two wireless interface protocols.
Clause 15 An arrangement according to any of the preceding clauses wherein at least two antennas are configured to provide MIMO operation.
Clause 16 An arrangement according to clause 4 wherein the groundplane of the antenna is proximate to a surface of the recess and is electrically insulated therefrom by a dielectric film such that a capacitive connection is made between the antenna groundplane and the proximate surface of the recess.
Clause 17 An arrangement according to clause 16 wherein the film is a double-sided adhesive tape, solder resist, and/or anodising of an aluminium recess surface.

### BRIEF DESCRIPTION OF THE DRAWINGS

FIG. 1(a) and FIG. 1(b) show external views of the ceiling mountable assembly.

FIG. 2 is a simplified cross section showing the device as mounted in a ceiling.

FIG. 3 is a view of a flange of the cylindrical device having four antennas positioned in openings therein.

FIG. 4 shows the groundplane side of an antenna.

FIG. 5 show the feed arrangements of an antenna.

FIG. 6 shows the antenna feed arrangement overlaid on the groundplane.

FIG. 7 is a detailed view of the accommodation for one antenna within a recess in a flange of the ceiling mounted device.

FIG. 8 is a graph showing the measured return loss of an antenna accommodated in the flange of the ceiling mounted device.

FIG. 9 is a graph showing the measured efficiency of an antenna accommodated in the flange of the ceiling mounted device.

FIG. 10 shows the radiation patterns of an antenna accommodated in the flange of the ceiling mounted device measured in the 2.4-GHz frequency band.

FIG. 11 shows the radiation patterns of an antenna accommodated in the flange of the ceiling mounted device measured in the 5-GHz frequency band.

FIG. 12 illustrates the sample P1.

FIG. 13 illustrates the impedance of P1

FIG. 14 shows Sample 2 as optimised for measurement.

FIG. 15 shows Sample 2 impedance.

FIG. 16 shows Sample 3 as optimised for measurement.

FIG. 17 shows Sample 3 impedance

FIG. 18 shows Return loss of sample 3 in free space and in sample ceiling materials.

FIG. 19 shows Sample 3a as optimised for measurement.

FIG. 20 shows return loss of sample 3a in free space and in the ceiling materials.

### DETAILED DESCRIPTION

In the following description the antennas are described as physical entities distinct from the outwardly projecting flanges of the conductive housing of the host device. However it is to be understood that from a functional point of view the antennas and the host device form a single electromagnetic entity. By reason of the small dimensions of the antenna in terms of the operating wavelength it is necessary for the electromagnetic fields created within the structure of the antenna to excite radiating currents in the conductive host device. For this reason the conductive groundplane of the antenna is capacitively connected to the groundplane provided by the outwardly projecting conductive flange of the host device. Capacitive coupling is preferred to direct galvanic connection because it mitigates the possibility of intermetallic corrosion between the copper groundplane of a typical printed circuit laminate and the metallic flange onto which the antenna is mounted. An insulating layer may be provided between the groundplane of the antenna and the conductive flange by means of double-sided adhesive tape, solder resist on the groundplane or anodising of an aluminium flange.

The invention is further described by reference to the drawings.

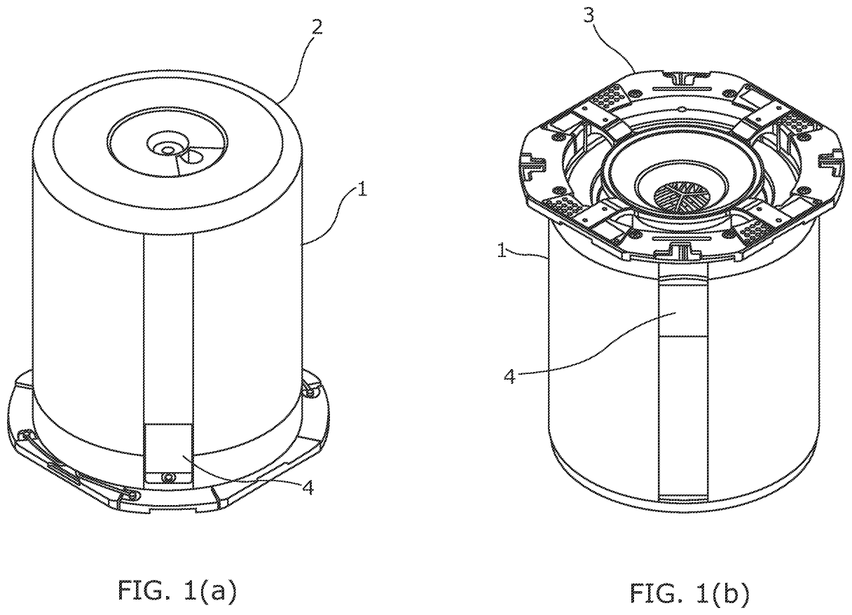

FIG. 1 shows external views of the ceiling mountable assembly comprising a cylindrical body 1, a closure on an upper end of the cylindrical body 2, a mounting flange 3 on a lower end of the cylindrical body and spring retaining member 4. FIG. 1(a) shows the assembly in its orientation when mounted, while FIG. 1(b) shows it inverted.

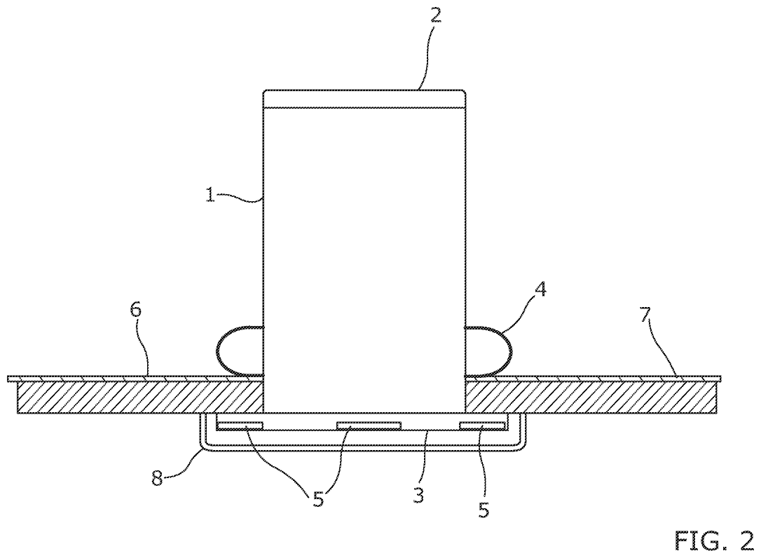

FIG. 2 shows a simplified view of the mounted assembly in which an upper surface of the flange component 3 is in contact with a lower surface of a supporting planar member 6 and is held in place by at least two spring retaining members 4. The planar member 6 may form a ceiling or other structural component of a building and preferably comprises an electrically insulating material such as plasterboard, MDF or plywood. Planar member 6 may support a metallic foil 7 on its upper surface to enhance thermal insulation.

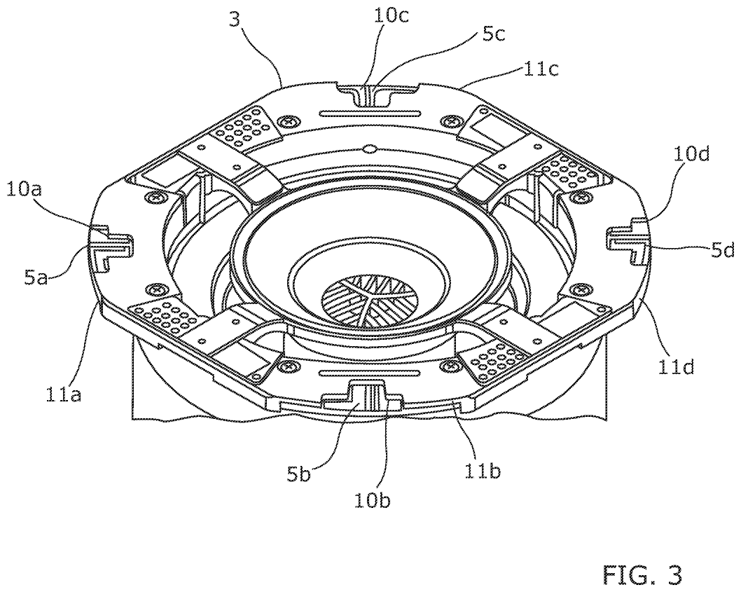

FIG. 3 shows an enlarged view of the flange component 3 seen obliquely from below in the configuration as mounted (FIG. 2), having recesses 11a, 11b, 11c, 11d and openings 10a, 10b, 10c, 10d, each of said recesses having a corresponding antenna 5a, 5b, 5c, 5d respectively mounted within it so that the antenna is aligned with the opening. The flange 3 may be in the form of a truncated circle, wherein the antennas are positioned in the regions having circular profile and maximum radial extent. The dimensions of the recesses 11a, 11b, 11c, 11d in the flange 3 are chosen together with those of the antennas 5 such that the antennas are entirely accommodated within the recesses. The dimensions of the openings 10 are chosen such that when the antennas 5 are each placed within a recess in the flange, the openings 21, 23 in the groundplane 20 of the antenna 5 closely match the openings 10 such that the edges of the openings lie between 0.5 mm and 1.0 mm within the groundplane in both radial and circumferential directions. This ensures that the conductive flange does not encroach on the functional area of the antenna while providing sufficient proximate area between the conductive groundplane of the antenna and the conductive flange to enable the flow of radio frequency currents by the capacitance thereby provided.

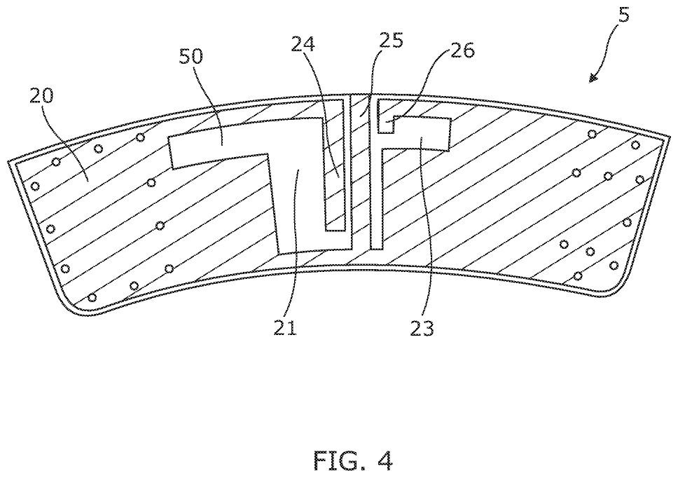

FIG. 4 shows a first surface of the antenna 5 comprising a first surface of a dielectric lamina 50 provided with a conductive foil groundplane 20 having a first opening 21 and a second opening 23 separated by a conductive region 25. The first opening 21 is arranged to be resonant in the 2.4-GHz frequency band and the second opening 23 is arranged to be resonant in the 5-GHz frequency band. The resonant frequency of the opening 21 is determined by its dimensions and also by the capacitance provided between conductive regions 24 and 25. In like manner the resonant frequency of the opening 23 is determined by its dimensions and also by the capacitance provided between conductive regions 26 and 25.

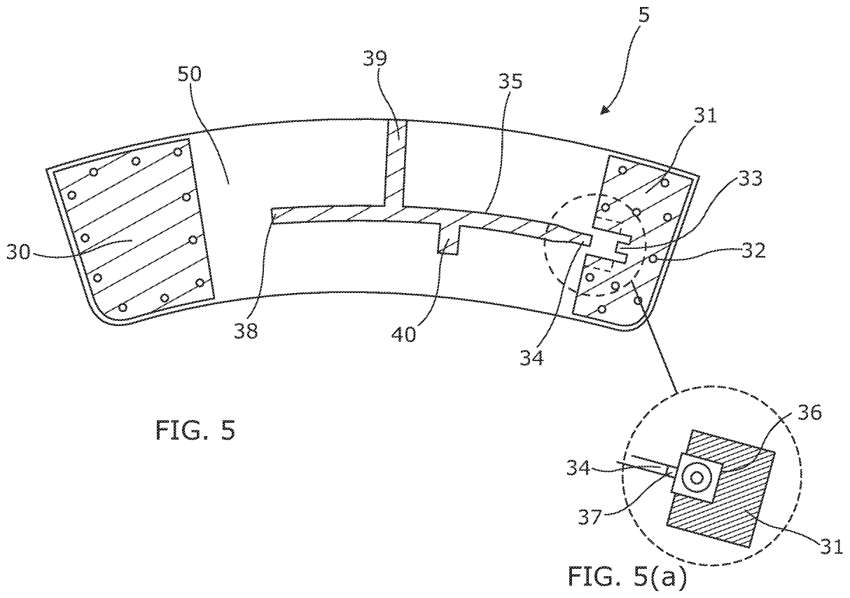

FIG. 5 shows a second surface of the antenna 5 comprising conductive foils on a second surface of the dielectric lamina 50. The image is oriented such that the corresponding features of the first and second surface are shown in the same relative position, that is as if seen through the dielectric lamina. A ground area of conductive foil 30 is provided at a first end of the second surface of the antenna and a ground area 31 is provided at a second end of the second surface of the antenna. Plated-through holes 32 (vias) are provided between the conductive foils 30, 31 and the groundplane 20 on the first surface of the antenna, such vias being positioned close to the periphery of conductive areas 30, 31 and typically spaced at intervals not exceeding 6 mm. An opening 33 is provided in the conductive area 31 to enable the placement of a subminiature coaxial connector, for example type W.FL. As shown in FIG. 5(a) the said connector is placed such that its body 36 may be connected by soldering to the conductive area 31 and its inner conductor 37 may be connected by soldering to the end 34 of microstrip transmission line 35.

The elongate microstrip transmission line 35 is preferably of arcuate form but may alternatively be of linear form. It extends from the coaxial connector 37 to an open circuit at its distal end 38 and has lateral branches 39, 40. Branch 39 preferably overlies the conductive member 25 formed in the groundplane foil on the first surface of the antenna.

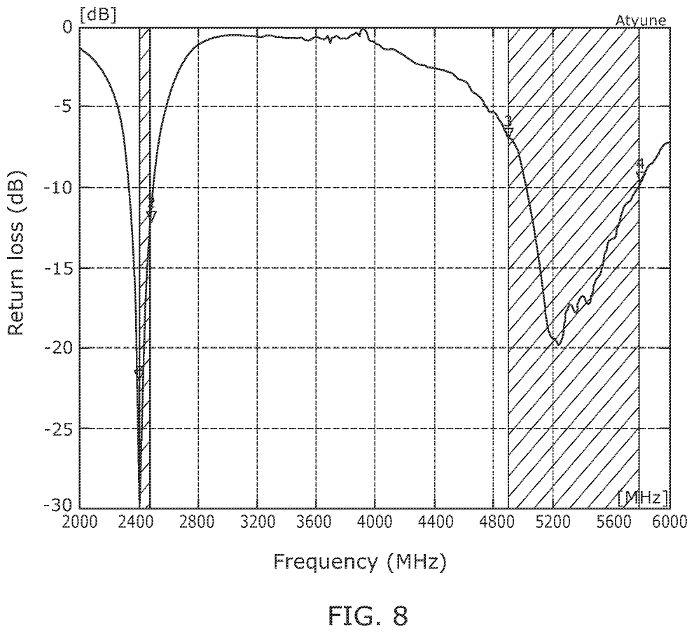

The dimensions of openings 21, 23 may be determined by experiment or by simulation using suitable commercially available computer software. The width of the transmission line 35, the position of its distal open circuit end 38, and the length and width of each of the lateral branch lines 39, 40 are optimised by design together with the dimensions of the openings in the groundplane such that the input impedance of the antenna, when measured with the antenna placed within the recess 11 in the flange 3, is minimised across each of the operating frequency bands. By way of example the measured voltage standing wave ratio (VSWR) may be less than 3:1 across each of the frequency bands 2.4-2.485 and 4.9-5.8 GHz. This corresponds to a return loss exceeding 6 dB as shown in FIG. 8.

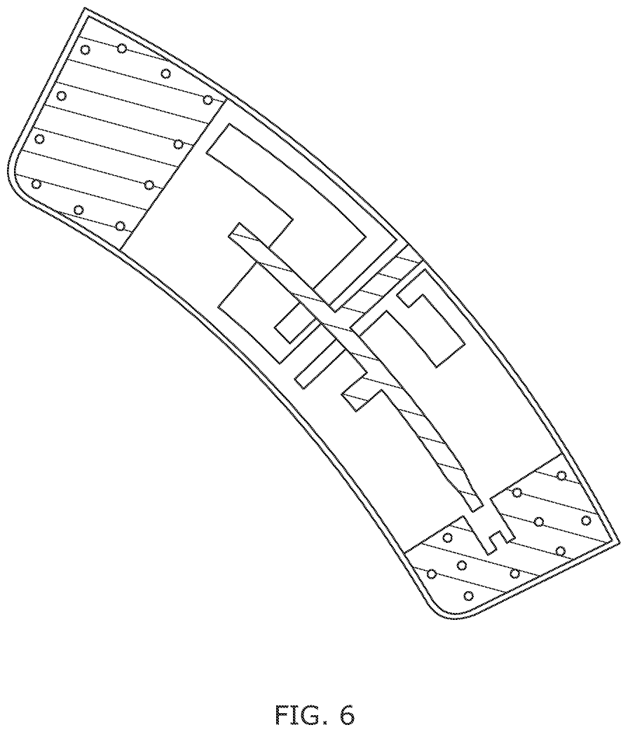

FIG. 6 shows overlaid views of the conductive foil on the first and second surfaces of the antenna. It will be seen that the microstrip line 35 passes across the openings 21, 23 in the underlying conductive foil 20.

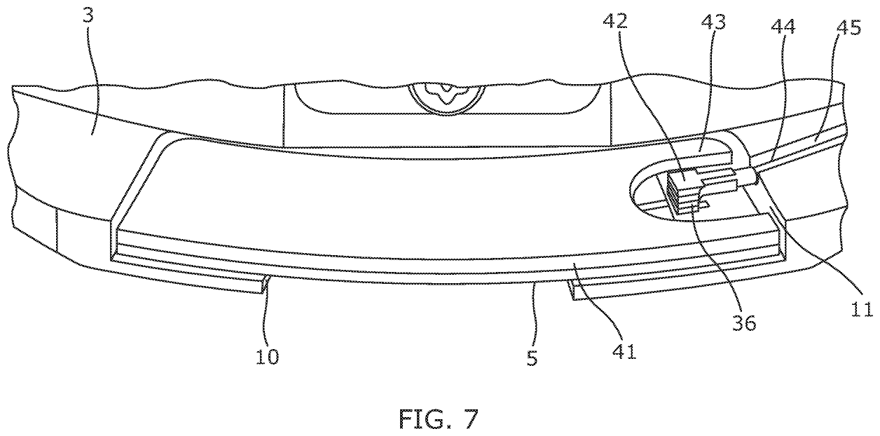

FIG. 7 shows the antenna 5 positioned within recess 11 and proximate to opening 10 in the flange 3. A subminiature coaxial cable 44 positioned within a groove 45 in the flange 3 is connected by a coaxial plug 42 to the antenna connector 36. The distal end of coaxial cable 44 is connected to radio communications circuits. To protect the antenna 5 from damage, a second dielectric lamina 41 having no conductive foil on any surface is adherently connected to the antenna. Such connection may be provided by double-sided adhesive tape or by the use of a standard printed circuit board lamination process. The second dielectric lamina 41 is provided with an opening 43 to provide accommodation for the coaxial connectors 36, 42.

The depth of the recess 11 is chosen to be greater than the thickness of the antenna 5 together with the assembled height of the coaxial socket 36 and mating plug 42, such that no part of the antenna or the connected cable projects above the surface of the flange 3.

In a practical embodiment the printed circuit laminate accommodating the complete antenna had a radial dimension of 9.0 mm, an external circumferential dimension of 34 mm and was constructed on dielectric laminate 0.8-mm thick. The overall dimensions of the groundplane opening for the 2.4-GHz frequency band were 7 mm (radially)×9 mm (circumferentially), and those for the 5-GHz frequency band were 7 mm (radially)×4 mm (circumferentially). The antenna was constructed on glass-epoxy laminate having a relative permittivity of 4.0. The microstrip feed line 35 had a width of 1.0 mm and overlapped the groundplane 20 by 1.2 mm at its open circuit end. The larger branch conductor 39 was 1 mm wide×4.5 mm long and the shorter branch 40 was 1.0 mm wide×1.5 mm long and was positioned 7 mm from the input end of the coaxial socket.

The thickness of the dielectric lamina was 0.8 mm. The maximum assembled height of a coaxial plug and socket of type W.FL is 1.55 mm so the minimum required depth of the recess was 2.35 mm. W.FL2 is has a maximum assembled height of 1.3 mm so the minimum depth of the recess may be reduced to 2.10 mm with this connector. The cylindrical housing was 92.8 mm in diameter and 114 mm long, with a mounting flange extending 9.51 mm from the cylindrical housing (in some examples, the flange extends a maximum of 9.0 mm from the housing).

When optimally dimensioned the antenna requires no external matching network and no discrete internal tuning or matching components.

FIG. 8 shows the measured return loss of an antenna constructed according to the dimensions provided above and mounted in a plasterboard ceiling.

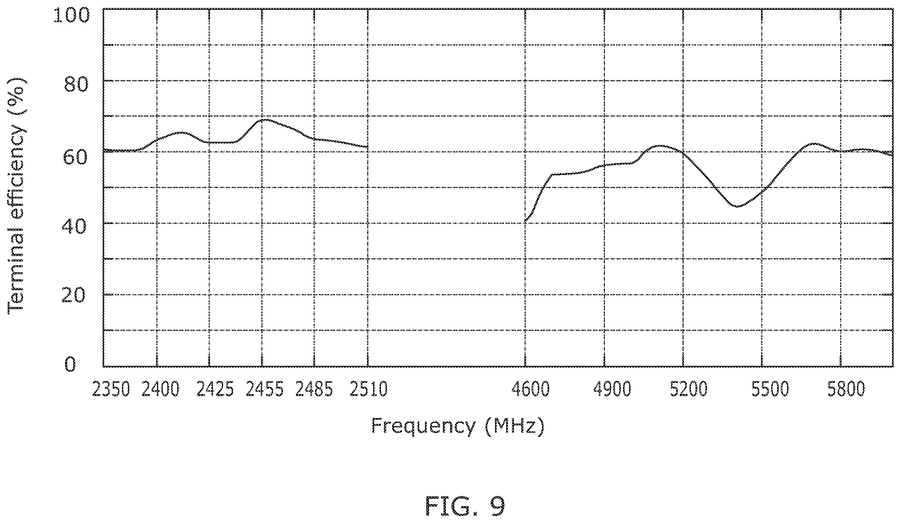

FIG. 9 shows the efficiency of the antenna, measured in a Satimo Stargate-64 chamber.

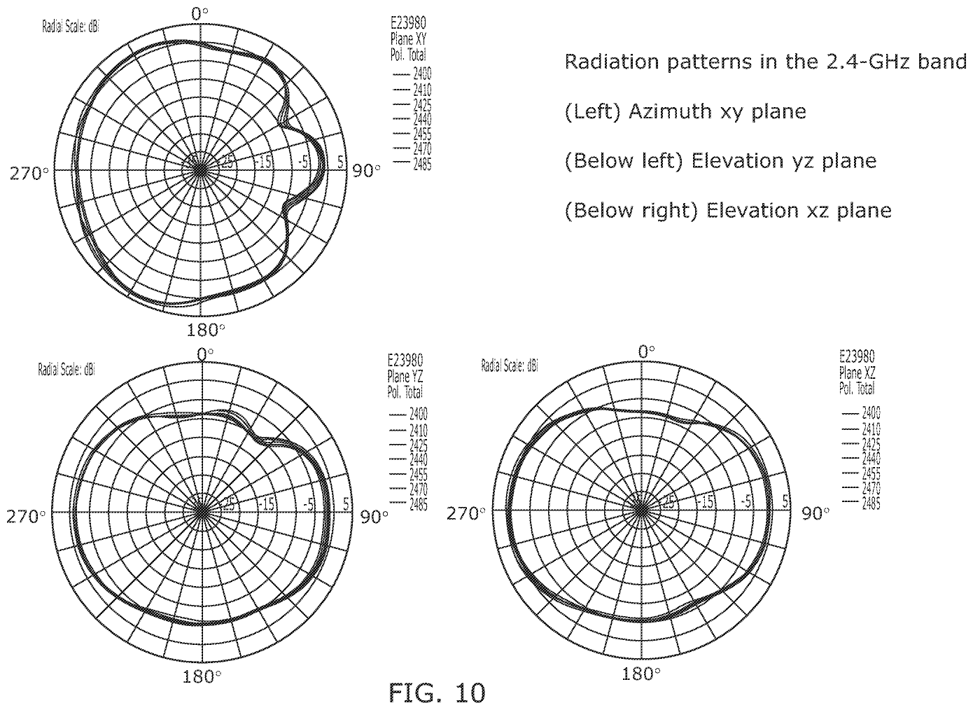

FIG. 10 shows radiation patterns and gain of the antenna in the 2.4-GHz frequency band measured in azimuth and elevation planes.

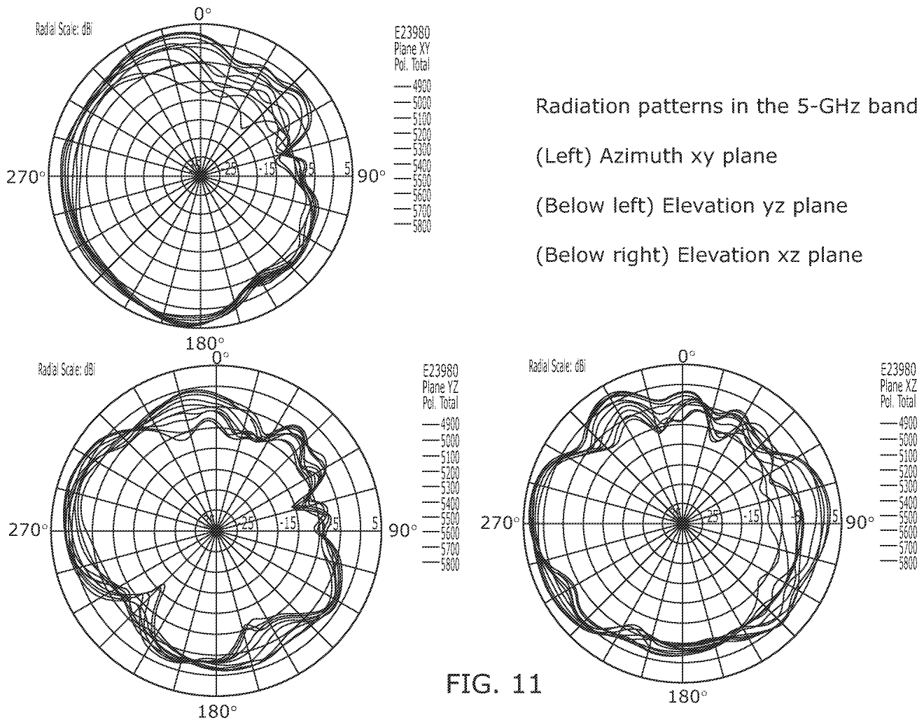

FIG. 11 shows radiation patterns and gain of the antenna in the 5-GHz frequency band measured in azimuth and elevation planes.

As would be expected from antennas mounted on a conducting platform, the radiation patterns are not omnidirectional in the azimuth plane. In order to optimise the use of the antenna configuration a first antenna and a second antenna having azimuth bearings separated by 180 degrees (with the device mounted as shown in FIG. 2) are preferably fed to two diversity inputs of a first radio device while a third antenna and a fourth antenna, mutually oriented at 90 degrees in the azimuth plane relative to the first and second antenna, are connected to two diversity inputs of a second radio device. This arrangement, when combined with the multipath propagation characteristics of a typical indoor environment provides a high level of data throughput and communications reliability.

The arrangement provides a mutual isolation between the antennas exceeding 25 dB in the 2.4-GHz frequency band and exceeding 28 dB in the 5-GHz frequency band, permitting their simultaneous use for different radio systems without suffering mutual interference.

In an alternative implementation the radio signals from each of the four antennas may be connected to radio circuits providing MIMO (multiple input multiple output) functionality.

### EXPERIMENTAL NARRATIVE

A number of sample antennas were provided on 0.8-mm thick 370HR produced by a milling machine.

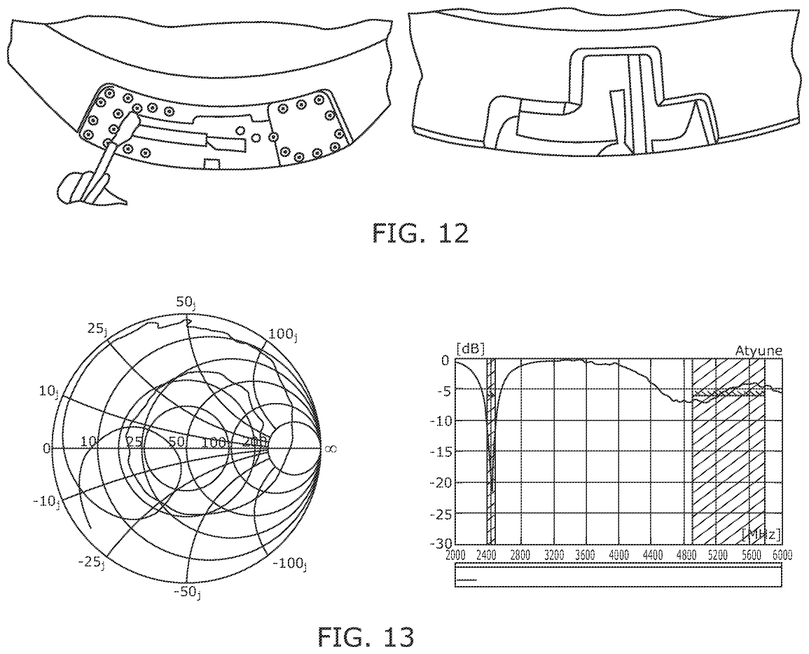

FIG. 12 illustrates the sample P1. FIG. 13 illustrates the impedance of P1

Sample 1 was fitted with via rivets and after adjustment produced the impedance shown in FIG. 13. The frequency of the two working bands is approximately correct. The impedance plot has a loop passing close to the chart centre at 2.4 GHz and curled round the centre at 5 GHz. This is the expected behaviour, but the impedance needs improving by getting a tighter curl at 5 GHz without degrading 2.4 GHz.

The impedance was measured with the antenna grounded to the chassis, separated by a thick card and also mounted using double sided tape. the results are slightly different in each case, but by much less than with the original version. The feed cable was wrapped three times through a ferrite ring to decouple the cable, but the effect of the cable is now much less than with the original breadboard models.

Sample 1 was set aside as a possible candidate for chamber testing. The objective of this first chamber test is to make sure that the efficiency of the antenna is sensibly consistent with the impedance plot, i.e. that losses are not significantly higher than would be expected from reflection loss. This creates confidence that when the impedance is further improved, efficiency will also be improved.

The ground area of sample 1 is more than it was hoped would be needed, so this should be reduced if at all possible.

Sample 2 was prepared, cutting the ground and the notches to the dimensions cut more approximately on sample 1. The edges of board were trimmed to make sure the copper would not contact the cylindrical surface of the chassis. The feed line was removed apart from a small tag to solder the connector inner, and replaced with a narrower track. After careful optimisation the results in FIG. 13 were obtained. This is much closer to what is needed. The difference in measured impedance with and without the ferrite choke on the cable is now negligible. The result does not change significantly with cable position at either band.

The radial trace on the ground side provides a capacitance which allows adjustment of the centre frequency of the 2.4-GHz response. The radial trace on the feed side helps to centre the impedance plot on the 5-GHz band. The lengths of the tuning line and the overlap of the main feed line with the ground side of the larger notch are both critical; trimming has been by the smallest increments possible with a sharp scalpel—probably less than 0.2 mm.

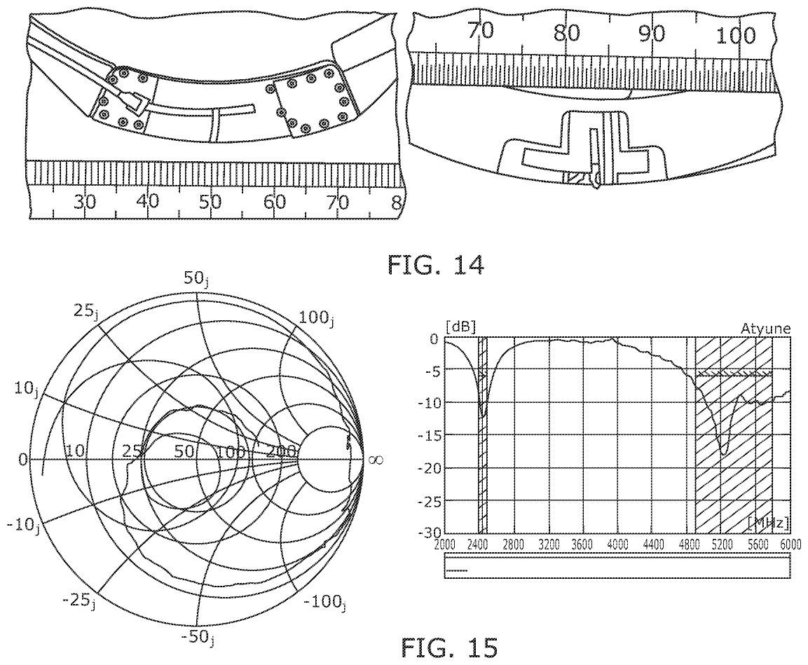

FIGS. 14 and 15 show the dimensions and impedance of this sample which will be kept as the default sample for measurements at the chamber.

FIG. 14 shows Sample 2 as optimised for measurement. The feedline here is copper tape; the provided track was removed apart from a 1.5-mm length close to the connector.

FIG. 15 shows Sample 2 impedance.

Sample 3: Reducing the width of the feed track from the connector moved the impedance plot to the right (larger R component). It would still be good to move further, so for sample 3 the width of the feed track will be reduced from 1.0 mm to 0.7 mm.

The extension of the larger notch was cut radially 2.2 mm wide and is 5.0 mm long; the extension of the small notch is 2.2 mm wide and 3.0 mm long. Both extensions are aligned with the outer edge of the existing notches. The tuning line is 0.6 mm wide and initially 7 mm long to allow for trimming to the correct frequency. It is aligned with the outer end of the large notch. The original feed line was trimmed straight (not curved) to 0.7 mm wide. The ground on each side of the feed was left in place.

Sample 4: The input feed line, as supplied, was trimmed to 0.7 mm wide. A slightly more complex arrangement used at the open circuit end of the feedline, but some improvement in return loss was achieved.

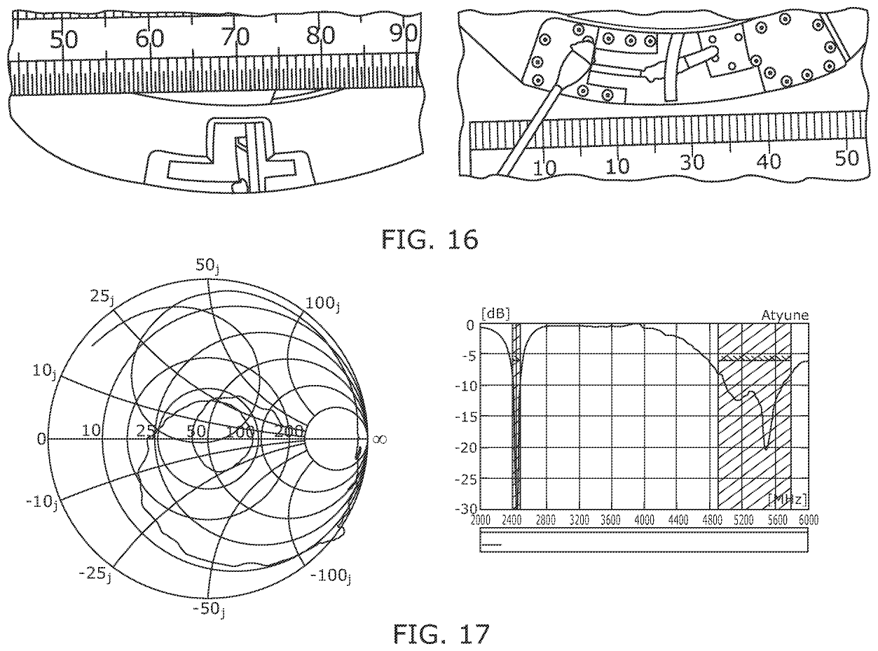

FIG. 16 shows Sample 3 as optimised for measurement. The feedline is as supplied but reduced in width. FIG. 17 shows Sample 3 impedance

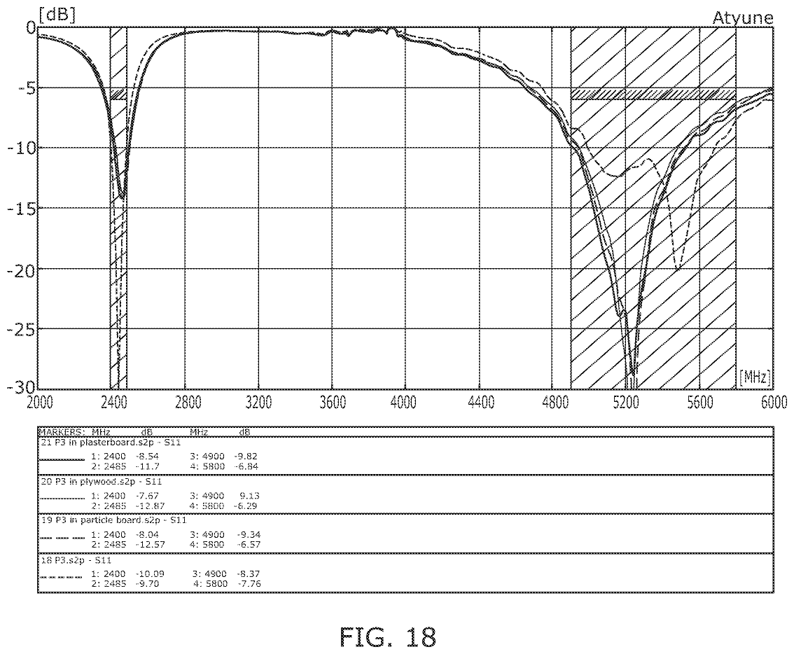

The provided ceiling material samples were slightly modified by cutting a small radial groove to clear the U.FL connectors and cable, This was necessary because the present flange thickness assumes the use of a smaller connector. the groove was kept to a minimum size to avoid changing the antenna performance. The return loss of sample 3 in free space and in the samples is shown in FIG. 18.

FIG. 18 shows Return loss of sample 3 in free space and in sample ceiling materials. As expected, the least dense material (plywood) shows least effect at 2.4 GHz, but all the material had a similar effect at 5 GHz.

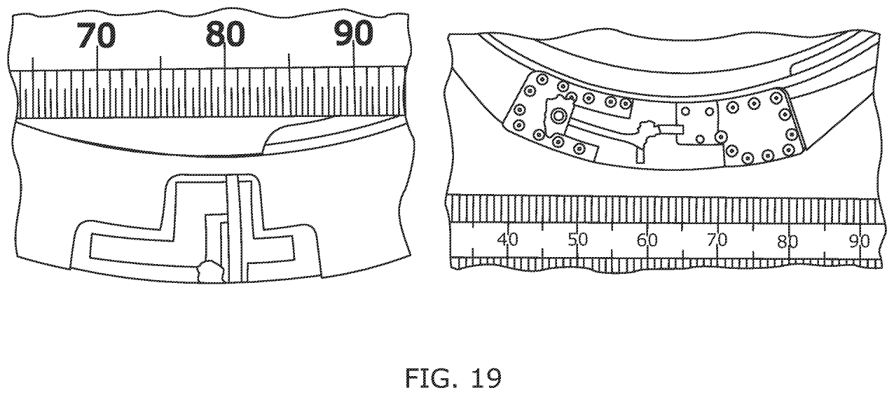

Sample 3 was modified by extending its low band notch by 2 mm. The feed was remade and adjusted to provide a bias towards the upper part of both bands in free space. The arrangement and return loss measurements are shown in FIG. 19.

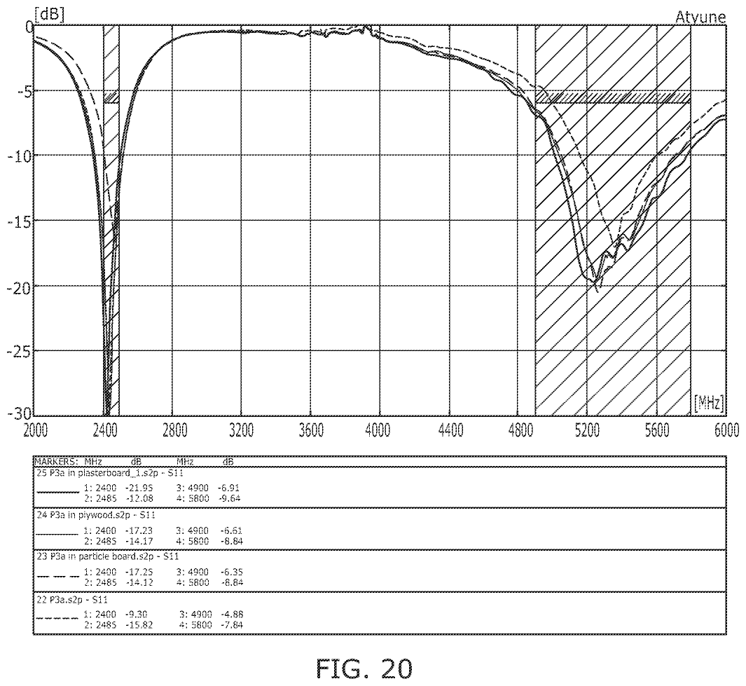

FIG. 19 shows Sample 3a as optimised for measurement FIG. 20 shows return loss of sample 3a in free space and in the ceiling materials

Despite increasing the length of the small notch the frequency of best match has moved up. It will be interesting to see how the chamber results correlate with the return loss measurements. A second position for an antenna will now be prepared to allow measurement of the isolation between antennas in position on the chassis.

1. An antenna comprising:
a dielectric lamina having a first face and a second face opposite the first face;
a groundplane on the first face of the dielectric lamina, wherein the groundplane is a planar conductive groundplane comprising first and second L-shaped apertures; and
a microstrip transmission line on the second face of the dielectric lamina.

2. The antenna of claim 1, wherein the groundplane comprises an edge and:
wherein the first L-shaped aperture is adjacent to the edge of the groundplane so that a first conductive track is defined by a portion of the groundplane between the edge of the groundplane and the first L-shaped aperture; and/or
wherein the second L-shaped aperture is adjacent to the edge of the groundplane so that a second conductive track is defined by a portion of the groundplane between the edge of the groundplane and the second L-shaped aperture.

3. The antenna of claim 1, wherein the first and second L-shaped apertures are adjacent each other so that a third conductive track is defined by the portion of the groundplane between the first and second L-shaped apertures.

4. The antenna of claim 1,
wherein the first L-shaped aperture comprises:
a first edge parallel to the edge of the groundplane so that a first conductive track is defined between the edge of the groundplane and the first edge of the first aperture,
a second edge opposite the first edge of the first aperture, and
a third edge extending between the first and second edges of the first aperture, and/or
wherein the second L-shaped aperture comprises:
a first edge parallel to the edge of the groundplane so that the second conductive track is defined by a portion of the groundplane between the edge of the groundplane and the first edge of the second aperture, and
a second edge opposite the first edge of the second aperture and parallel to the first edge of the second aperture, and
a third edge extending between the first and second edges of the second aperture wherein the third edge of the second aperture is adjacent the third edge of the first aperture so that a third conductive track is defined by a portion of the groundplane between the third edge of the first aperture and the third edge of the second aperture.

5. The antenna of claim 4, wherein the first L-shaped aperture comprises a fourth edge between the second edge of the first aperture and the first edge of the first aperture and opposite the third edge of the first aperture, wherein the fourth edge of the first L-shaped aperture is formed as a step.

6. The antenna of claim 4, wherein the second L-shaped aperture comprises a fourth edge between the second edge of the second aperture and the first edge of the second aperture and opposite the third edge of the second aperture, wherein the fourth edge of the second L-shaped aperture is formed as a step.

7. The antenna of claim 4, wherein the groundplane further comprises:
a first gap between the first conductive track and the third conductive track; and/or
a second gap between the second conductive track and the third conductive track.

8. The antenna of claim 7, wherein the groundplane further comprises:
a fourth conductive track extending from an end of the first conductive track adjacent the first gap towards the second edge of the first aperture.

9. The antenna of claim 8, wherein the fourth conductive track extends at least 50% of the distance across the first aperture.

10. The antenna according to claim 7, further comprising a fifth conductive track that extends from an end of the second conductive track adjacent the second gap towards the second edge of the second aperture.

11. The antenna of claim 1, wherein the transmission line passes across first and second portions of the second face of the dielectric laminar that are opposite each of the first and second L-shaped apertures, respectively.

12. The antenna of claim 1, wherein the transmission line comprises a first conductive track on the second face of the dielectric lamina, wherein the first conductive track of the transmission line is substantially parallel to the edge of the groundplane wherein a distal end of the first conductive track of the transmission line is an open circuit, wherein a proximal end of the first conductive track opposite the distal end provides a feed for the antenna.

13. The antenna of claim 12, wherein the transmission line further comprises a second conductive track on the second face of the dielectric lamina perpendicular to the first conductive track of the transmission line and opposite the third conductive track of the groundplane.

14. The antenna of claim 12, wherein the transmission line further comprises a third conductive track on the second face of the dielectric lamina perpendicular to the first conductive track of the transmission line.

15. The antenna of claim 12, further comprising a RF connector, wherein an inner connection of the RF connector is conductively connected to the proximal end of the transmission line.

16. The antenna of claim 15, wherein a first ground area is provided on the second face of the dielectric lamina opposite a portion of the groundplane on the first face of the dielectric lamina and conductively connected therewith, wherein an outer connection of the RF connector is conductively connected to the ground area.

17. The antenna of claim 1, wherein the first aperture is dimensioned to provide operation on a first frequency band and/or the second aperture is dimensioned to provide operation on a second frequency band.

18. An antenna arrangement comprising a substantially planar conductive member having a first face and a second face opposite the first face, and one or more recesses in the first face, wherein each recess has a respective antenna according to claim 1 mounted therein, wherein each antenna is connectable with a respective cable, wherein each recess is dimensioned to accommodate the respective antenna and respective cable, wherein each recess corresponds with a respective opening in the second face of the substantially planar conductive member, wherein each opening is shaped to align with the first and second L-shaped apertures in the groundplane of the respective antenna mounted in the respective opening.

19. The antenna arrangement of claim 18, wherein each opening in the second face of the planar conductive member is dimensioned so that the boundary of the opening is at least a predetermined distance from the first and second L-shaped apertures of the respective antenna.

20. The antenna arrangement according to claim 18, wherein the planar conductive member is a flange outwardly extending from a substantially cylindrical body.

21. The antenna arrangement according to claim 18, wherein the groundplane of each antenna is proximate to a surface of the respective recess and is electrically insulated therefrom by a dielectric film.

22. The antenna arrangement according to claim 21, wherein the dielectric film is provided by:
double-sided adhesive tape,
solder resist, and/or
anodising of an the proximate surface of the respective recess.

23. A lighting and/or loudspeaker device comprising an antenna arrangement according to claim 18.

24. The lighting and/or loudspeaker device according to claim 23, further comprising a housing having a front end from which light and/or sound is configured to project, wherein the antenna arrangement is provided in the form of a flange at the front end of the housing.

25. The lighting and/or loudspeaker device according to claim 24, wherein the lighting and/or loudspeaker device is suitable for mounting in a ceiling aperture in a ceiling, wherein the flange engages a front of the ceiling when the lighting and/or loudspeaker device is mounted in the ceiling aperture, wherein the lighting and/or loudspeaker device further comprises a biasing member mounted to the housing configured to engage and exert a force against a rear side of the ceiling when the lighting and/or loudspeaker device is mounted in the ceiling aperture to brace the lighting and/or loudspeaker device against the ceiling.
